(19) United States
(12) Patent Application Publication
(10) Pub. No.: US 2010/0147664 A1
(43) Pub. Date: Jun. 17, 2010

(54) Moisture-proof rotary switch structure and method for manufacturing the same

(76) Inventors: Chia-Wei Lin, Taoyuan (TW); Chi-Meng Phang, Taoyuan (TW); Chen-Hong Huang, Taoyuan (TW); Chien-Jen Chiu, Taoyuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/382,697

(22) Filed: Mar. 23, 2009

(30) Foreign Application Priority Data
Dec. 17, 2008 (TW) 97149145

(51) Int. Cl. H01H 19/14

(52) U.S. Cl. 200/336

(57) ABSTRACT

A moisture-proof rotary switch structure includes a casing unit, a substrate unit and a rotary unit. The casing unit has a casing, a first opening formed on one part of a top surface of the casing and a second opening formed on a bottom side of the casing, and the other part of the top surface of the casing is sealed. The substrate unit is disposed on the bottom side of the casing for sealing the second opening, and the substrate unit has a substrate and a plurality of conductive areas formed on a top surface of the substrate. The rotary unit has a rotary body and a conductive piece disposed around the rotary body. The conductive piece is selectably electrically connected between two of the conductive areas, and the rotary body has a top portion passing through the first opening and being exposed above the casing.

### BACKGROUND OF THE INVENTION

1. Field of the Invention

The present invention relates to a rotary switch structure and a method for manufacturing the same, and particularly relates to a moisture-proof rotary switch structure and a method for manufacturing the same.

2. Description of Related Art

Electronic devices are commonly applied in daily life, and rotary switches are important components of electronic devices to control their functions. In the common environment, rotary switches do not require to be moisture-proof. However, for high-level electronic devices, rotary switches require moisture-proof design of different grades.

Referring to FIGS. 1A and 1B, the rotary switch structure of the prior art at least includes a casing unit 1a and a rotary unit 2a passing through the casing unit 1a. The casing unit 1a has a casing 10a, and the casing 10a has a plurality of openings 100a formed on its top surface due to the patterns drawing process.

Moreover, the casing unit 1a is formed by a mold unit Ma (as shown in FIG. 1B). The mold unit Ma has a mold body M1a and an inner straight pin M2a passing through the casing 10a in order to separate the casing 10a from the mold body M1a of the mold unit Ma. Hence, when the casing 10a prepares to separate from the mold unit Ma (prepares to execute “patterns drawing process”), the inner straight pin M2a can be pulled upwards (shown as the arrows in the central process of FIG. 1B), so that the inner straight pin M2a is moved upwards to separate from the inner protrusion 101a of the casing 10a. Therefore, it is easy for the casing 10a to separate from the mold body M1a of the mold unit Ma (shown as the arrows in the final process of FIG. 1B).

However, the openings 100a are formed due to the usage of the inner straight pin M2a (shown as the arrows in the final process of FIG. 1B), so that external vapor or foreign matter would easily enter the inner portion of the casing 10a through the opening 100a. Hence, many inner metal elements (not shown) disposed in the casing 10a would rust or become polluted easily by external vapor or foreign matter, and the rotary switch structure of the prior art would loss its switch functionality.

### SUMMARY OF THE INVENTION

One particular aspect of the present invention is to provide a moisture-proof rotary switch structure. The present invention can prevent external vapor or foreign matter from entering an inner portion of a casing of the rotary switch structure, so that many inner metal elements disposed in the casing do not be rusted or polluted by external vapor or foreign matter, and the rotary switch structure of the present invention can maintain its switch function.

In order to achieve the above-mentioned aspects, the present invention provides a moisture-proof rotary switch structure, including: a casing unit, a substrate unit and a rotary unit. The casing unit has a casing, a first opening formed on one part of a top surface of the casing and a second opening formed on a bottom side of the casing, and the other part of the top surface of the casing is sealed. The substrate unit is disposed on the bottom side of the casing for sealing the second opening, and the substrate unit has a substrate and a plurality of conductive areas formed on a top surface of the substrate. The rotary unit has a rotary body and a conductive piece disposed around the rotary body. The conductive piece is selectably electrically connected between two of the conductive areas, and the rotary body has a top portion passing through the first opening and being exposed above the casing.

In order to achieve the above-mentioned aspects, the present invention provides a method for manufacturing a moisture-proof rotary switch structure, comprising: making a casing unit by a mold unit, the casing unit having a casing, a first opening formed on one part of a top surface of the casing and a second opening formed on a bottom side of the casing, the other part of the top surface of the casing being sealed, and the mold unit having an inner inclined pin in order to selectably hook an inner portion of the casing or separate the casing from the mold unit; disposing a rotary unit in the casing, the rotary unit having a rotary body and a conductive piece disposed around the rotary body, and the rotary body having a top portion passing through the first opening and being exposed above the casing; and then disposing a substrate unit on the bottom side of the casing for sealing the second opening, and the substrate unit having a substrate and a plurality of conductive areas formed on a top surface of the substrate, so that the conductive piece is selectably electrically connected between two of the conductive areas.

Therefore, because the first opening is formed on one part of the top surface of the casing and the other part of the top surface of the casing is sealed, the present invention can prevent external vapor or foreign matter from entering an inner portion of the casing of the rotary switch structure. Hence, many inner metal elements disposed in the casing do not be rusted or polluted by external vapor or foreign matter.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objectives and advantages of the present invention will be more readily understood from the following detailed description when read in conjunction with the appended drawings, in which:

FIG. 1A is a perspective, assembled, schematic view of a rotary switch structure according to the prior art;

FIG. 1B is a cross-sectional, schematic view of a casing unit of a rotary switch structure according to the prior art, at different stages of the partial packaging processes, respectively;

FIG. 2A is one perspective, exploded, schematic view of a rotary switch structure according to the present invention;

FIG. 2B is another perspective, exploded, schematic view of a rotary switch structure according to the present invention;

FIG. 2C is a cross-sectional, schematic view of a casing unit of a rotary switch structure according to the present invention, at different stages of the partial packaging processes, respectively;

FIG. 2D1 is a partial perspective, assembled, schematic view of a rotary switch structure without a substrate unit according to the present invention;

FIG. 2D2 is a partial bottom, assembled, schematic view of a rotary switch structure without a substrate unit according to the present invention;

FIG. 2E is one perspective, assembled, schematic view of a rotary switch structure according to the present invention;

FIG. 2F is another perspective, assembled, schematic view of a rotary switch structure according to the present invention; and

FIG. 3 is flowchart of a method for manufacturing a rotary switch structure according to the present invention.

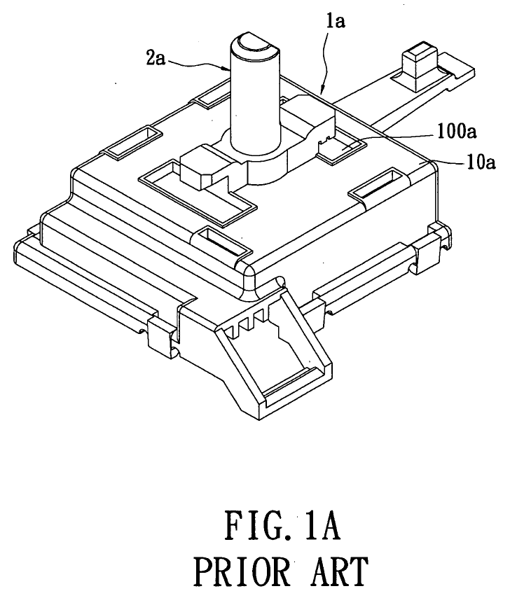

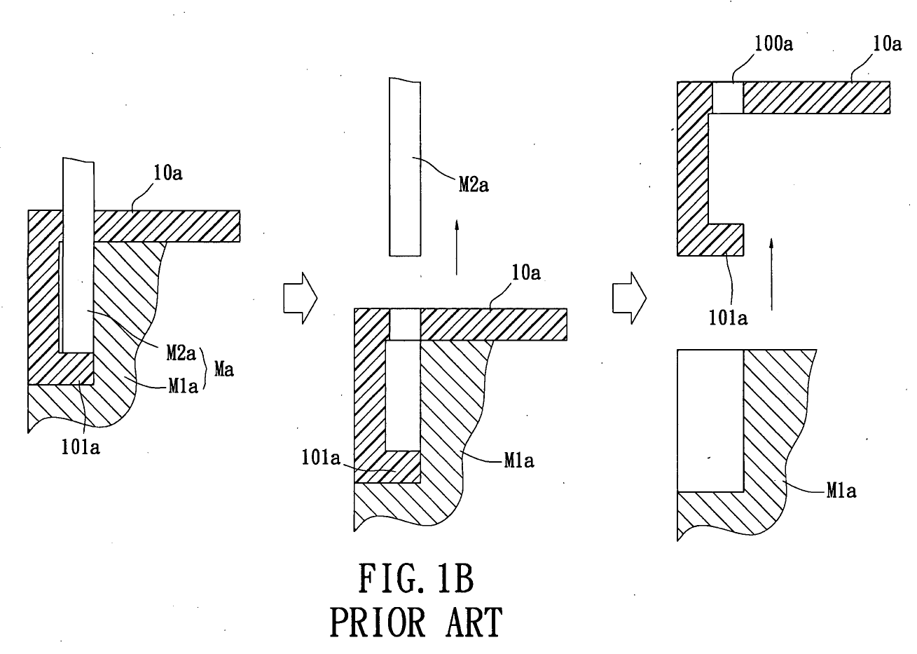

### DETAILED DESCRIPTION OF THE PREFERRED EMBODIMENTS

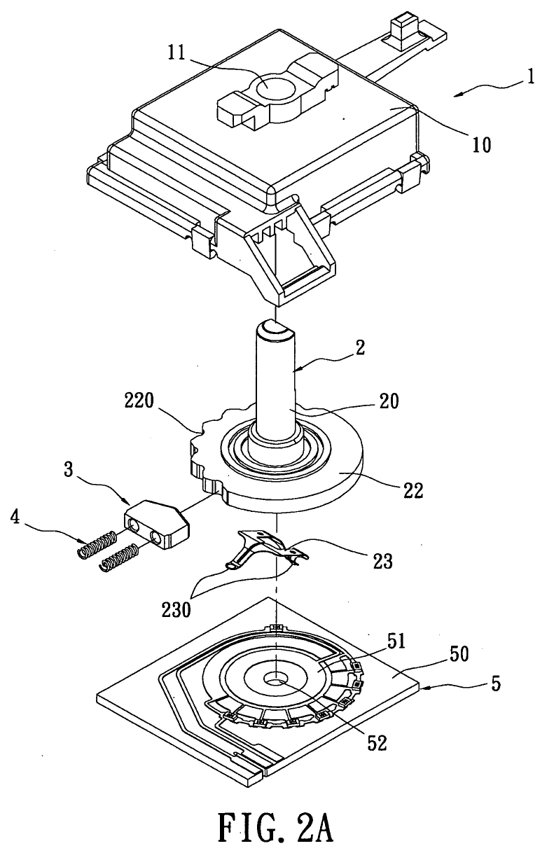

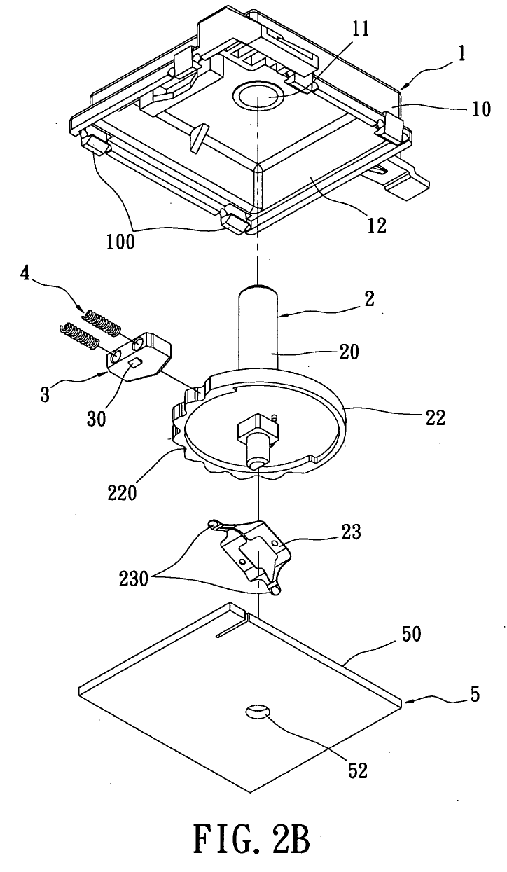

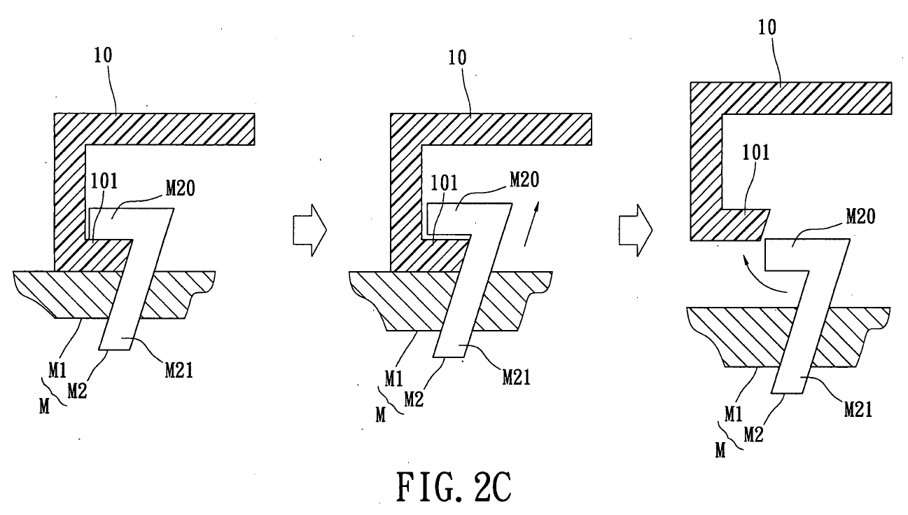

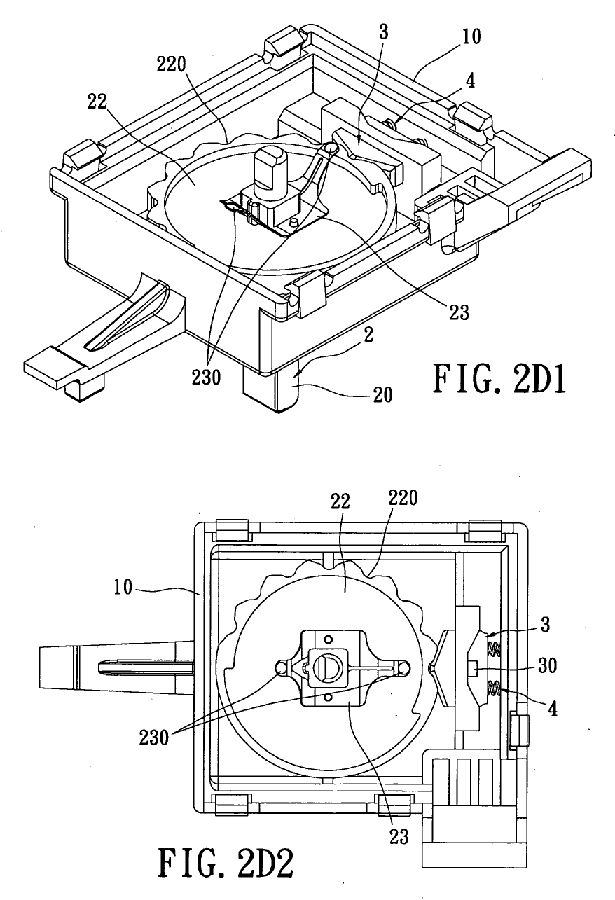

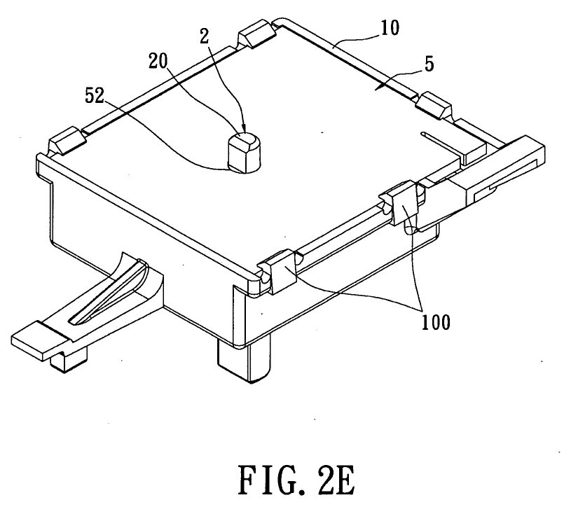

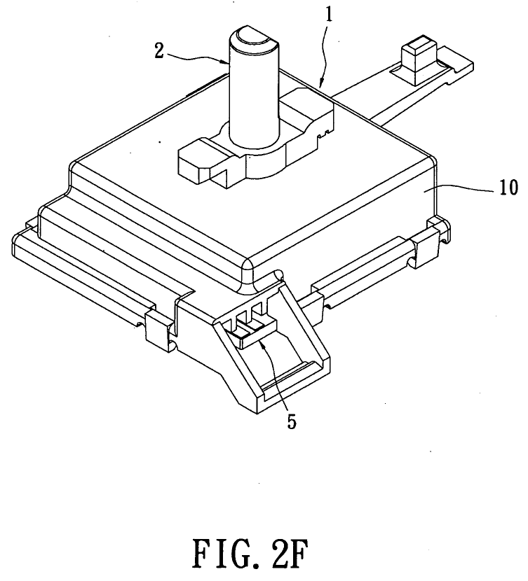

Referring to FIGS. 2A to 2F, the present invention provides a moisture-proof rotary switch structure, including: a casing unit 1, a rotary unit 2, a rotary positioning element 3, two flexible elements 4 and a substrate unit 5.

Referring to FIG. 2A to 2C again, the casing unit 1 has a casing 10, a first opening 11 formed on a top side of the casing 10 and a second opening 12 formed on a bottom side of the casing 10. The first opening 11 is formed on one part of a top surface of the casing 10 and the other part of the top surface of the casing 10 is sealed. In addition, the casing 10 has a plurality of retaining portions 100 extending downwards from an outer area of the bottom side thereof.

Moreover, the casing unit 1 is formed by a mold unit M. The mold unit M has a mold body M1 and an inner inclined pin M2 in order to selectably hook an inner portion of the casing 10 or separate the casing 10 from the mold body M1 of the mold unit M. The inner inclined pin M2 passes through the mold body M1. In the present invention, the inner inclined pin M2 has the shape of the cipher 7. The inner inclined pin M2 has a top portion M20 exposed above the mold body M1 to hook the inner portion of the casing 10, and the inner inclined pin M2 has a bottom portion M21 exposed under the mold body M1.

In other words, the top portion M20 of the inner inclined pin M2 hooks an inner protrusion 101 under the bottom side of the casing 10 (the inner protrusion 101 is extending inwards from an inner wall of the casing 10), so that the inner portion of the casing 10 is hooked by the top portion M20 of the inner inclined pin M2. Hence, when the casing 10 prepares to separate from the mold unit M (prepares to execute “patterns drawing process”), a upward force (shown as the arrows in the central process of FIG. 2C) can be forced onto the bottom portion M21 of the inner inclined pin M2, so that the top portion M20 of the inner inclined pin.M2 is moved upwards and rightwards to separate from the inner protrusion 101 of the casing 10. Therefore, it is easy for the casing 10 to separate from the mold unit M (shown as the arrows in the final process of FIG. 2C).

Furthermore, referring to FIGS. 2A, 2B, 2D1, 2D2 and 2E again, the rotary unit 2 has a rotary body 20. The rotary body 20 has a top portion passing through the first opening 11 and being exposed above the casing 10. In addition, the rotary unit 2 has a rotary disk 22 disposed at a middle portion of the rotary body 20 and a conductive piece 23 disposed under the rotary disk 22. The conductive piece 23 is disposed around the rotary body 20. The rotary disk 22 has a plurality of rotary grooves 220 formed around its outer side. The conductive piece 23 has at least two conductive protrusions 230.

In addition, the rotary positioning element 3 and the two flexible elements 4 are disposed in the casing 10. The rotary positioning element 3 has at least one retaining block 40, and the rotary positioning element 3 is restricted in the casing 10 by the retaining block 40. The two flexible elements 4 are disposed between the rotary positioning element 3 and an inner surface of the casing 10. In addition, the rotary positioning element 3 has a front side selectably received in one of the rotary grooves 220 in order to position the rotary unit 2 (as shown in FIGS. 2D1 and 2D2). In other words, the two flexible elements 4 provide force onto the rotary positioning element 3, so that the front side of the rotary positioning element 3 can be selectably received in one of the rotary grooves 220 in order to position the rotary disk 22 and the conductive piece 23.

Of course, the present invention may uses only one flexible element 4 disposed between the rotary positioning element 3 and the inner surface of the casing 10 (or more than two flexible elements 4 may be disposed between the rotary positioning element 3 and the inner surface of the casing 10). Hence, when the rotary disk 22 does not be rotated, the rotary positioning element 3 is restricted in the casing 10 by matching the retaining block 40 and one or more than one flexible element 4.

Moreover, the substrate unit 5 is disposed on the bottom side of the casing 10 for sealing the second opening 12. The substrate unit 5 has a substrate 50, a plurality of conductive areas 51 formed on a top surface of the substrate 50 and a hole 52 passing through the substrate 50. The substrate unit 5 is retained on the bottom side of the casing 10 by the retaining portions 100 (as shown in FIG. 2E). In addition, the conductive piece 23 uses the two conductive protrusions 230 to selectably electrically connected between two of the conductive areas 51 in order to provide different switch functions, and the rotary body 20 has a bottom portion passing through the hole 52 of the substrate unit 5.

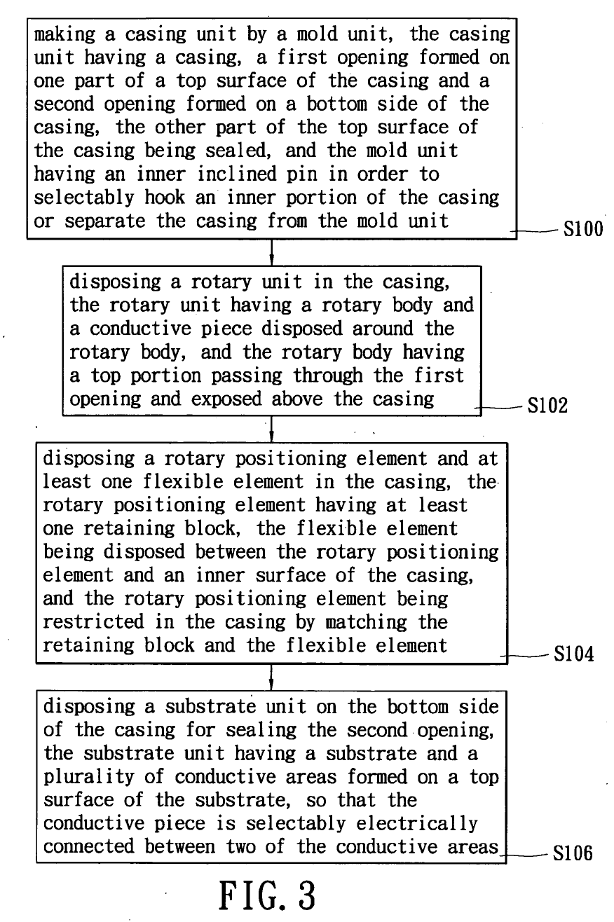

Referring to FIG. 3, the present invention provides a method for manufacturing a moisture-proof rotary switch structure. The method includes:

The step S100 is that: referring to FIGS. 3, 2A to 2C, making a casing unit 1 by a mold unit M, the casing unit 1 having a casing 10, a first opening 11 formed on one part of a top surface of the casing 10 and a second opening 12 formed on a bottom side of the casing 10, the other part of the top surface of the casing 10 being sealed, and the mold unit M having an inner inclined pin M2 in order to selectably hook an inner portion of the casing 10 or separate the casing 10 from the mold unit M.

The step S102 is that: referring to FIGS. 3, 2A and 2B, disposing a rotary unit 2 in the casing 10, the rotary unit 2 having a rotary body 20 and a conductive piece 23 disposed around the rotary body 20, and the rotary body 20 having a top portion passing through the first opening 11 and exposed above the casing 10.

The step S104 is that: referring to FIGS. 3, 2D1 and 2D2, disposing a rotary positioning element 3 and at least one flexible element 4 in the casing 10, the rotary positioning element 3 having at least one retaining block 30, the flexible element 4 being disposed between the rotary positioning element 3 and an inner surface of the casing 10, and the rotary positioning element 3 being restricted in the casing 10 by matching the retaining block 30 and the flexible element 4.

The step S106 is that: referring to FIGS. 3, 2A, 2B and 2E, disposing a substrate unit 5 on the bottom side of the casing 10 for sealing the second opening 12, the substrate unit 5 having a substrate 50 and a plurality of conductive areas 51 formed on a top surface of the substrate 50, so that the conductive piece 23 is selectably electrically connected between two of the conductive areas 51.

In conclusion, the present invention can prevent external vapor or foreign matter from entering an inner portion of the casing 10 of the rotary switch structure, so that many inner metal elements disposed in the casing 10 do not be rusted or polluted by external vapor or foreign matter.

Although the present invention has been described with reference to the preferred best molds thereof, it will be understood that the present invention is not limited to the details thereof. Various substitutions and modifications have been suggested in the foregoing description, and others will occur to those of ordinary skill in the art. Therefore, all such substitutions and modifications are intended to be embraced within the scope of the present invention as defined in the appended claims.

What is claimed is:

1. A moisture-proof rotary switch structure, comprising:
a casing unit having a casing, a first opening formed on one part of a top surface of the casing and a second opening formed on a bottom side of the casing, wherein the other part of the top surface of the casing is sealed;
a substrate unit disposed on the bottom side of the casing for sealing the second opening, wherein the substrate unit has a substrate and a plurality of conductive areas formed on a top surface of the substrate; and
a rotary unit having a rotary body and a conductive piece disposed around the rotary body, wherein the conductive piece is selectably electrically connected between two of the conductive areas, and the rotary body has a top portion passing through the first opening and being exposed above the casing.

2. The rotary switch structure as claimed in claim 1, wherein the casing has a plurality of retaining portions extending downwards from an outer area of the bottom side thereof, and the substrate unit is retained on the-bottom side of the casing by the retaining portions.

3. The rotary switch structure as claimed in claim 1, wherein the substrate unit has a hole passing through the substrate, and the rotary body has a bottom portion passing through the hole.

4. The rotary switch structure as claimed in claim 1, further comprising: a rotary positioning element and at least one flexible element, wherein the rotary positioning element and the flexible element are disposed in the casing, the rotary positioning element has at least one retaining block, the flexible element is disposed between the rotary positioning element and an inner surface of the casing, and the rotary positioning element is restricted in the casing by matching the retaining block and the flexible element.

5. The rotary switch structure as claimed in claim 4, wherein the rotary unit has a rotary disk disposed at a middle portion of the rotary body, the rotary disk has a plurality of rotary grooves formed around its outer side, and the rotary positioning element has a front side selectably received in one of the rotary grooves in order to position the rotary unit.

6. The rotary switch structure as claimed in claim 5, wherein the conductive piece is disposed under the rotary disk, and the conductive piece has at least two conductive protrusions selectably electrically connected between two of the conductive areas.

7. A method for manufacturing a moisture-proof rotary switch structure, comprising:
making a casing unit by a mold unit, wherein the casing unit has a casing, a first opening formed on one part of a top surface of the casing and a second opening formed on a bottom side of the casing, the other part of the top surface of the casing is sealed, and the mold unit has an inner inclined pin in order to selectably hook an inner portion of the casing or separate the casing from the mold unit;
disposing a rotary unit in the casing, wherein the rotary unit has a rotary body and a conductive piece disposed around the rotary body, and the rotary body has a top portion passing through the first opening and being exposed above the casing; and
disposing a substrate unit on the bottom side of the casing for sealing the second opening, wherein the substrate unit has a substrate and a plurality of conductive areas formed on a top surface of the substrate, so that the conductive piece is selectably electrically connected between two of the conductive areas.

8. The method as claimed in claim 7, wherein the inner inclined pin has the shape of the cipher 7.

9. The method as claimed in claim 7, wherein the mold unit has a mold body, the inner inclined pin passes through the mold body, the inner inclined pin has a top portion exposed above the mold body to hook the inner portion of the casing, and the inner inclined pin has a bottom portion exposed under the mold body.

10. The method as claimed in claim 7, wherein the casing has a plurality of retaining portions extending downwards from an outer area of the bottom side thereof, and the substrate unit is retained on the bottom side of the casing by the retaining portions.

11. The method as claimed in claim 7, wherein the substrate unit has a hole passing through the substrate, and the rotary body has a bottom portion passing through the hole.

12. The method as claimed in claim 7, wherein before the step of disposing the rotary unit in the casing, the method further comprises: disposing a rotary positioning element and at least one flexible element in the casing, wherein the rotary positioning element has at least one retaining block, the flexible element is disposed between the rotary positioning element and an inner surface of the casing, and the rotary positioning element is restricted in the casing by matching the retaining block and the flexible element.

13. The method as claimed in claim 12, wherein the rotary unit has a rotary disk disposed at a middle portion of the rotary body, the rotary disk has a plurality of rotary grooves formed around its outer side, and the rotary positioning element has a front side selectably received in one of the rotary grooves in order to position the rotary unit.

14. The method as claimed in claim 13, wherein the conductive piece is disposed under the rotary disk, and the conductive piece has at least two conductive protrusions selectably electrically connected between two of the conductive areas.
